(19) United States
(12) Patent Application Publication
(10) Pub. No.: US 2017/0213283 A1
(43) Pub. Date: Jul. 27, 2017

(54) DEVICE AND A COMPUTER SOFTWARE FOR PROVISIONING A USER WITH REQUESTED SERVICES

(71) Applicant: INNOVATIVE ASSESSMENTS INTERNATIONAL LTD., Shoham (IL)

(72) Inventor: Saul FINE, Shoham (IL)

(21) Appl. No.: 15/403,467

(22) Filed: Jan. 11, 2017

Related U.S. Application Data
(60) Provisional application No. 62/286,385, filed on Jan. 24, 2016.

(51) Int. Cl. G06Q 40/02; G06F 17/30; G06Q 40/08

(52) U.S. Cl. CPC G06Q 40/025; G06Q 40/08; G06F 17/30864

(57) ABSTRACT

A communication device for determining, prior to provisioning a service to a user of a computing device, whether to provide that user with a requested service. The communication device comprises: a network interface configured to communicate with the computing device and with at least one data source; and a processor adapted to communicate with the network interface, and configured to: receive request for a service from a user; forward to the at least one data source information regarding this request and user's identifying details; retrieve data that relates to the request; determine, based on the retrieved data, a set of queries; forward the set of queries to the computing device; receive from the computing device responses to the set of queries; determine an adequacy score based on the retrieved data and the responses; and when the adequacy score is above a predefined threshold, enable provisioning the requested service.

### CROSS-REFERENCE TO RELATED APPLICATIONS

This application claims priority from U.S. Provisional Patent Application No. 62/286,385, filed Jan. 24, 2016, the entire contents of which is incorporated herein by reference in its entirety.

### TECHNICAL FIELD

The disclosure generally relates to a system for managing resources for the provisioning services to a user of a communication system, and more particularly, to a system and method to allow determining whether a user of a communication system should be provided with requested services.

### BACKGROUND

Recent advances in digital information processing have made a wide range of services and functions available for delivery to consumers at their premises. These services and functions include among others digital programming (movies, etc.), digital information retail and e-commerce, as well as high-speed Internet access and IP-based telephony (e.g., VoIP). Other services available to network users include access to provisioning digital banking, loans, and insurance plans.

Currently, many of these services are provided and delivered to the user via a wide variety of different equipment environments including, inter alia, cable modems, Wi-Fi hubs, Ethernet hubs, gateways, computers, servers, and cellular telephones/smartphones. Additionally, the services associated with such technology are typically provided by multiple vendors including e.g., a cellular service provider (CSP), wireless service provider (WSP), Internet service provider (ISP), credit bureaus, and financial institutions etc.

Certain services which may be requested by a user require assessing users' risk behaviors. However, traditional methods for assessing such risk behaviors may not always be adequate, because they do not directly capture and integrate important personal competencies. This issue may be emphasized when users access such services via the internet. We live in an age of unprecedented access to financial services, for example, where consumers can attain unsecured online loans or insurance coverage in minutes, with little or no human interaction. While this situation brings with it great efficiency and potential for economic growth, it also brings with it the increased risk of erroneous and potentially biased decisions on the part of the service provider, who makes decisions regarding consumers' predicted future behaviors, without considering certain personal attributes.

Specifically, in the case of lending, Western economies rely primarily on consumer credit bureau scores to make credit decisions. Credit bureau scores are based almost entirely on individuals' historical financial data, and thereby overlook a key factor of creditworthiness: personal character.

With respect to credit, personal character is an essential determinant of consumers' “willingness” to repay loans, while bureau credit scores focus on consumers' “ability” to repay. Character is therefore a critical, but mostly missing, consideration in modern lending decisions.

In addition, because credit scores rely on historical data, those without sufficient credit histories, such as the many millions of young adults and new immigrants, are Often automatically assumed to be high credit risks, and are either unfairly charged exorbitant rates or are denied credit altogether. This, despite their possible actual ability and willingness to repay. In such cases, applicants' personal competencies could help demonstrate creditworthiness above and beyond that reflected by bureau credit scores alone.

Similarly, in the case of insurance or healthcare applications, predictive models of behavioral risks are based primarily on prior incidents (or lack thereof) and/or demographics, and do not address relevant aspects of personal character, which can be significant determinants of future safety and adherence behaviors. One of the best-known methods for assessing personal character and competencies is via psychometrics. It would therefore be beneficial to provide a solution that overcomes the deficiencies of the prior approaches by generating more accurate and integrated psychometrics assessment of a consumer applicant's risk behavior.

### SUMMARY OF THE DISCLOSURE

The disclosure may be summarized by referring to the appended claims.

It is an object of the present invention to provide a new device and a method for determining whether a user will be provisioned with a service he/she has requested.

It is an object of the present invention to provide a new device and a method for performing an adequacy inspection of a user in order to determine whether to provide that user with a requested service.

Other objects of the present invention will become apparent from the following description.

According to a first embodiment of the present disclosure, there is provided a communication device for determining, prior to provisioning a service to a user of a computing device, whether that user may be provided with a requested service (e.g. by performing an adequacy inspection of that user), wherein the communication device comprising:

a network interface configured to communicate with the computing device of said user and with at least one first processing device (e.g. a processor associated with a data source); and

at least one second processing device adapted to communicate with the network interface, wherein the at least second processing device is configured to:
receive from the computing device a request for a service to be provisioned to the user of the computing device;
forward to the at least one first processing device information associated with the request received, and at least one detail associated with the user of the computing device (e.g. the user's name, the user's I.D. etc.);
retrieve from the at least one first processing device data that relates to the request;
determine, based on the retrieved data, a set of queries;
forward the set of queries to the computing device;
receive from the computing device one or more responses to queries included in the set of queries;
determine an adequacy score based on the retrieved data and the one or more responses; and
when the adequacy score is above a predefined threshold, enable provisioning the requested service to the user of the computing device.

The term “computing device” as used herein throughout the specification and claims is used to denote a device that is configured to communicate with other devices while using a communication network and is provided with a user interface and processing capabilities, such as a desktop, a laptop, a smartphone, a tablet, any other mobile communication device, and the like.

According to another embodiment, the requested service is provisioning of digital information and the at least one detail associated with the user is that user's age (e.g., services not available to minors) or geographical location (e.g., services not available to certain states or countries).

In accordance with another embodiment, the set of queries includes at least one of: a query regarding the user's experience with similar services, a query regarding a desired quality of service, and a query regarding a version of the data content to be provided to the user.

By yet another embodiment, upon determining that the adequacy score is above the predefined threshold, a data file would be forwarded towards the user's computing device.

According to still another embodiment, upon determining that the adequacy score is below the predefined threshold, the at least second processing device is configured to send a message to the computing device, that comprises information identifying a different data file, e.g. different digital information that may be forwarded to the user.

By yet another embodiment, the requested service is a financial service and the at least one detail associated with the user is a data identifying the user (e.g. an ID number).

According to another embodiment, the financial service is a member selected from a group that consists the following members: a) a loan, b) an insurance coverage, c) a combination thereof.

In accordance with another embodiment, the set of queries comprises psychometric queries.

In accordance with another embodiment, the at least one first processing device is at least one server hosting a website, and the retrieved data includes historical information associated with the user.

According to still another embodiment, the determined set of queries are designed to assess a variety of personal character traits.

In accordance with yet another embodiment, the at least one second processor is further configured to analyze one or more responses received to the set of queries and to identify therefrom information about at least one of: user's opinions, user's attitudes, user's character traits, user behaviors in similar cases, and user's honesty in responding to the psychometric queries.

By still another embodiment, provisioning of the requested service to the computing device comprises transmitting a message indicating that the financial service has been approved.

According to another aspect of the present disclosure there is provided a computer program product encoding a computer program stored on a non-transitory computer-readable medium for executing a set of instructions by one or more computer processors for carrying out the method for performing an adequacy inspection prior to provisioning a service to a user of a computing device, wherein the method comprising:
receiving from the computing device a request for a service to be provided to the user of the computing device;
forwarding information associated with the request received, and at least one detail associated with the user of the computing device to at least one processing device;
retrieving from the at least one processing device data that relates to the request;
determining, based on the retrieved data, a set of queries;
forwarding the set of queries to the computing device;
receiving from the computing device one or more responses to queries included in the set of queries;
determining an adequacy score based on the retrieved data and the one or more responses; and
if the adequacy score is above a predefined threshold, enabling provisioning the requested service to the user of the computing device.

According to another embodiment of this aspect, the requested service is receipt of data (e.g. media) content.

In accordance with another embodiment of this aspect of the disclosure, the computer program product is further configured to allow forwarding of a data file towards the computing device upon determining that the adequacy score is above the predefined threshold.

According to another embodiment, the computer product is configured to enable provisioning a financial service and the at least one detail associated with the user is a detail which is capable of identifying the user (e.g. the user's name, the user's ID, and the like).

Preferably, the financial service is a provisioning of a loan to the user, or provisioning of an insurance coverage to the user, or a combination thereof.

In accordance with another embodiment of this aspect of the disclosure, the at least one processing device is at least one server hosting a website, and the retrieved data includes historical information associated with the user.

According to another embodiment, the determined set of queries is designed to assess a variety of personal character traits.

By yet another embodiment of this aspect, provisioning the requested service to the user computing device comprises transmitting a message indicating that the financial service has been approved.

According to another aspect of the disclosure, there is provided a method for generating assessment scores of a user, the method comprising:

receiving at a server one or more personal parameters that enable identification of the user;

identifying by the server, a computer application currently used by the user;

retrieving by the server from at least one data source, historical data associated with the identified user;

generating by the server a set of queries (e.g. psychometric questions) based on the historical data associated with the user and the computer application currently used by that user, and forwarding (e.g. transmitting) these queries to a computing device of the user;

receiving by the server one or more responses to the set of queries;

carrying out an analysis for assessing the user based on the historical data retrieved, the computer application used by the user, and the one or more responses received; and

generating an assessment score of that user.

According to another embodiment, the method further comprises: generating a test for the user based on: the historical data retrieved and/or the computer application used by the user, and/or the one or more responses received; forwarding the test to the computing device of the user; receiving the test results and incorporating them in the analysis when carried out for assessing the user.

By yet another embodiment, the method further comprising to analyze the one or more responses to the set of queries and to identify therefrom information about at least one of: user's opinions, user's attitudes, user's character traits, user behaviors in similar cases, and user's honesty in responding to the psychometric queries.

### BRIEF DESCRIPTION OF THE DRAWINGS

For a more complete understanding of the present invention, reference is now made to the following detailed description taken in conjunction with the accompanying drawings wherein:

FIG. 1—is a message sequence chart exemplifying an exchange of message between various constituents of a system construed in accordance with an embodiment of the present disclosure;

FIG. 2—is a schematic block diagram of a system for generation of an integrated psychometric assessment score according to one embodiment of the present invention; and

FIG. 3—is flow diagram exemplifying a method carried out in accordance with an embodiment of the present invention of generation an integrated psychometric assessment score according to one embodiment of the invention.

### DETAILED DESCRIPTION

In this disclosure, the term “comprising” is intended to have an open-ended meaning so that when a first element is stated as comprising a second element, the first element may also include one or more other elements that are not necessarily identified or described herein, or recited in the claims.

In the following description, for the purposes of explanation, numerous specific details are set forth in order to provide a better understanding of the present disclosure by way of examples. It should be apparent, however, that the present invention may be practiced without these specific details.

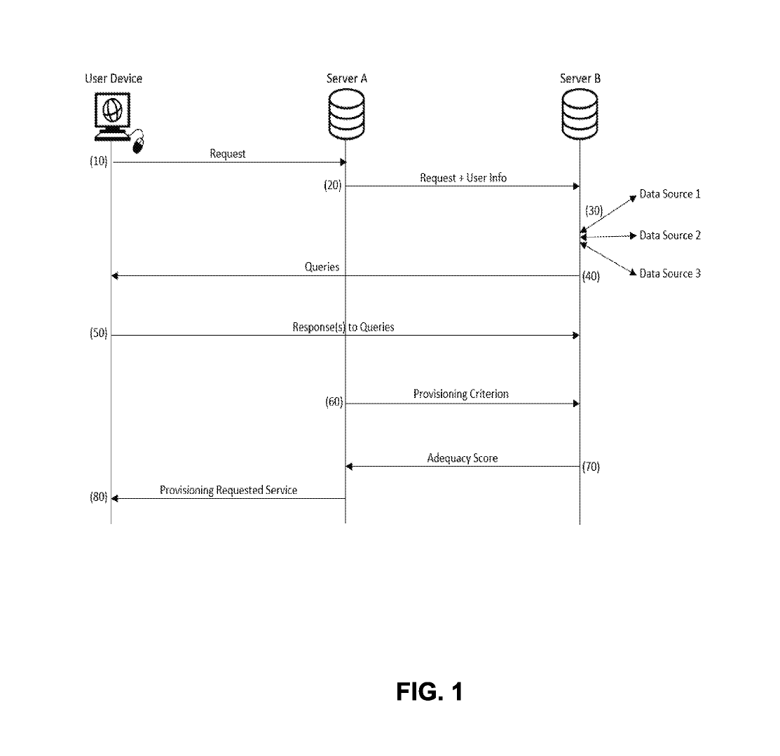

FIG. 1 is a message sequence chart exemplifying an exchange of messages between various constituents of a system construed in accordance with an embodiment of the present disclosure. According to this example, the messages' exchanges begins with a message (10) sent by a communication device of a user, identifying a request to be provisioned with a certain service. Such a request may relate to any one of a number of services such as for example a mobile telephony related service, or a financial service such as obtain credit from a lender, and the like.

The request message (10) is forwarded to server A, where it is processed and then a message (20) that comprises both identification of the requested service as well as identifying information (e.g. an I.D.) of the user is forwarded to server B. Server B then sends a message (30) requesting information which relates to that user to one or more data sources (e.g. any one or more data sources 1-3 shown in FIG. 1), and upon receiving the relevant information from these one or more data sources, generates a set of queries for the specific user, which is forwarded (40) towards the user device.

The user replies to these queries by forwarding his/her responses (50) towards the server where the queries were generated (server B in this example). In addition, server A forwards to server B at any point of the process exemplified herein a message (60) that comprises a provisioning criteria, i.e. at least one criterion that is a condition to provisioning the requested service.

Based on the two received messages (50) and (60), server B returns to server A a message (70) that comprises information that relates to the user's adequacy, e.g. a message indicating the adequacy level of the user regarding the requested service.

Once message (70) is received by server A, it determines whether the requested service should be provisioned to that user (and possibly determine the scope at which the service will be provided, e.g. it can determine that based on the adequacy score only a partial service out of the requested service will be provided to that user), and then (80) provides the service accordingly, or forwards a message to the user device indicating to the user that he/she is not eligible to be provisioned with the requested service.

Although the above example was described with reference being made to use of two servers (server A and server B), as would be appreciated by those skilled in the art

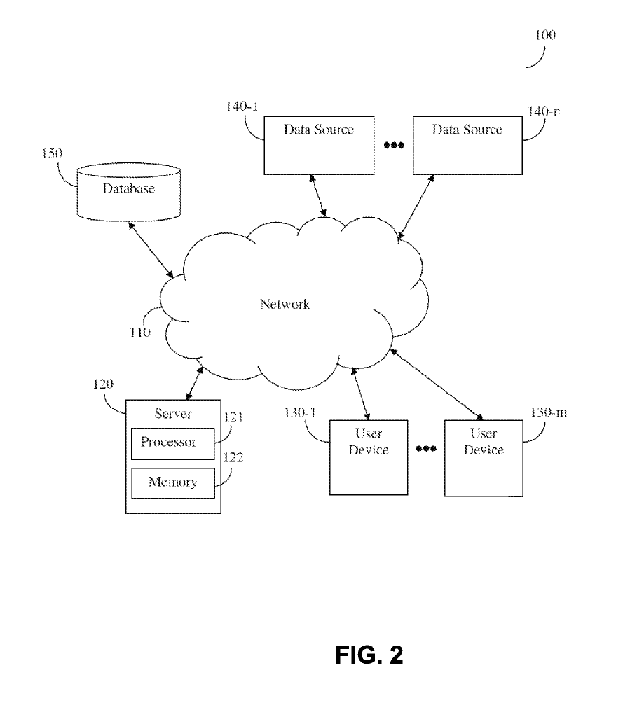

FIG. 2 is a schematic block diagram of a system that is adapted for generating an integrated psychometric assessment score according to one embodiment of the present invention, wherein the integrated consumer-centric psychometric assessment score enables entities such as, enterprises, banks, insurance companies, and the like, to estimate behavioral risks associated with an applicant's personal character, in addition to his/her personal historical information.

The system is configured to receive personal parameters associated with the applicant. It then identifies details associated with the user's application, following by retrieval (directly or indirectly) of historical data associated with the applicant, preferably data which relates to the applicant's application, from at least one data source. Upon retrieval of the historical data, a set of psychometric queries is generated based upon the retrieved parameters, data and details, and the set of queries is forwarded to the applicant.

Upon receiving the user's response to the set of queries, the response is analyzed (e.g. the analysis may involve personal parameters and/or the historical data, and/or details regarding the user's application and/or the psychometric responses, and an integrated psychometric score associated with the applicant is generated.

FIG. 2 illustrates an exemplary, non-limiting schematic diagram of a system 100 for generating an integrated psychometric assessment score for at least one applicant (hereinafter: “the user”) according to an embodiment of the invention. Several components comprised in system 100 are coupled to communication network 110. Network 110 may be a local area network (LAN), a wide area network (WAN), a metro area network (MAN), the worldwide web (WWW), the Internet, wired and/or wireless networks, and any combination thereof. A server 120 is communicatively connected to network 110 and comprises a processing unit, such as a processor 121 and a memory 122. Memory 122 is adapted to store instructions that when executed by the processor 121 enable configuring server 120 to execute actions as further described herein below. System 100 includes one or more user devices 130, associated with users i.e., user devices 130-1 through 130-m, that are communicatively connected to network 110. The system 100 further includes one or more data sources 140, i.e., data sources 140-1 through 140-n, that are communicatively connected to network 110. The data sources 140 may be web sites associated with entities such as, for example, banks, insurance companies, etc. A database 150 is further communicatively connected to network 110. The database 150 contains a variety of psychometric questions.

According to an embodiment, server 120 receives from user device 130 one or more personal parameters associated with at least one user of the user device 130. The personal parameters may include data such as for example, user's residence, user's employment, user's income, user's demographic information, etc. The server 120 then identifies from the user device 130 at least one detail respective of a user's application. The user's application is a request made by the user with reference to the desired service or product.

The user's application may be for example, a loan application, an insurance application, etc. The at least one detail respective of the user's application may be, for example, the amount of money requested by the user for a loan, a type of insurance, etc. Server 120 then identifies, in at least one data source 140, historical data associated with the at least one user who is associated with user device 130, that relate to the identified at least one detail associated with the user's application. The historical data may be for example information provided in a computer readable medium indicative of the user's history activity, such as, for example, the user's financial bureau credit score.

Server 120 then generates a set of psychometric queries based on the received parameters, data and details, and forwards it to the user device 130. The queries are then displayed to the user at user device 130. Psychometric queries (or statements) are questions that are meant to assess a variety of personal character traits associated with a user, for example, a user's competencies, attitudes, opinions, personality traits, honesty in replying to questions, the user behaviors in similar cases, etc. The queries may be sent for storage in a database 150. The server 120 then receives responses from the user device 130 associated with the user to the set of queries, where the responses may include self-reported ratings to the questions and/or response times, for example. Once processed by the server 120 and analyzed via a scoring algorithm, as further described herein below, enables determining at least one user's personal character traits, which reflects an initial psychometric assessment of the behavioral risk tendencies in the user's application scenario.

According to one embodiment, server 120 may terminate the execution upon determining, based on the responses received, that the user's parameters do not meet the necessary predetermined minimum required threshold of the application process. For example, server 120 may receive responses that may indicate that the user is under the age of 18 or has insufficient funds (in the case of consumer credit), rendering the remaining steps in the scoring process unnecessary in some situations.

Next, server 120 generates an integrated psychometric score associated with the at least one user respective of an analysis of the one or more personal parameters, the at least one detail respective of the application, the historical data, and the set of psychometric responses. The integrated psychometric score aggregates the aforementioned data as a representation of user's overall level of risk, which easily enables evaluating the user's suitability for the purpose of the application, such as for example, credit, insurance, healthcare, etc. According to an embodiment, the server 120 displays the integrated psychometric score and/or its subcomponent scores and/or information on a display of the user device 130.

According to an optional embodiment, server 120 generates a psychometric assessment test respective of the analysis of the one or more personal parameters, the historical data, the at least one detail associated with the user's application, the set of responses, and the psychometric score. According to one embodiment, server 120 displays the psychometric assessment test on the display of the user device 130.

According to yet another optional embodiment, the integrated psychometric score and/or its sub-component scores and/or information are delivered to a service provider's applicant management system.

As a non-limiting example of generating a psychometric score according to the disclosed method, system 100 receives data that indicates that the user is a 30-year-old retail sales person that lives in New York City, with a debt-to-income ratio of 25%, and requests a loan of 3,000 US dollars. System 100 provides a set of psychometric queries to the user respective of the received data, and receives the user's responses that, after carrying out a computer analysis, indicate that the user's personal character score is 85 out of 100, which is relatively a high score and above the minimum that was predefined as a threshold for this application type. The system 100 further identifies that the user has a bureau credit score of 620, which is a relatively low score, but still above the minimum threshold for this application type, and that the user has no outstanding loans or bankruptcies. Upon collecting this data by system 100, it is analyzed in order to generate an integrated psychometric score associated with the user. In this case, when taking the above into consideration, the integrated psychometric score that would be generated by system 100 will be a relatively high score.

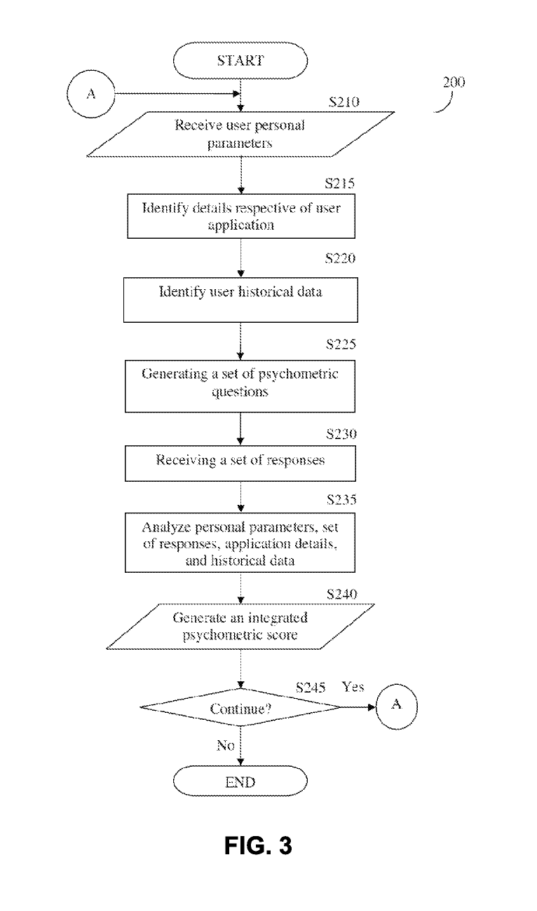

FIG. 3 depicts an exemplary and non-limiting flowchart 200 of a method for generation of an integrated psychometric assessment score according to an embodiment. In step 210, the operation starts when server 120 (of the system described in connection with FIG. 2) receives one or more personal parameters associated with the at least one user from the user device 130. The personal parameters are received by server 120 from the user device 130 based on the data entered by the user. The personal parameters may include data such as for example, user's residence, user's employment, user's income, user's relevant demographic information, etc. In step 215, server 120 retrieves based on data sent from user device 130, at least one detail associated with the user's application. In step 220, server 120 identifies from at least one data source 140, historical data associated with the at least one user. In step 225, server 120 generates a set of psychometric questions based on the received and identified parameters, data and details and forwards the set of psychometric questions towards user device 130. Server 120 further displays the psychometric questions on a display unit of the user device 130. The set of psychometric questions may be stored in a database 150.

In step 230, server 120 receives one or more responses from user device 130 regarding the set of psychometric questions that had been forwarded thereto. The one or more responses, once processed by the server 120, enable determining at least one of user's personal character traits, which reflects part of the behavioral risk tendencies in the user's application scenario. In step 235, server 120 analyzes the one or more personal parameters, the identified historical data, the at least one detail respective of the application and the one or more responses received. In step 240, server 120 generates an integrated psychometric score associated with the at least one user respective of the analysis.

In step 245, the system checks whether to proceed with the process and if in the affirmative, the execution of the process continues, otherwise, the execution of the process is terminated.

According to an optional embodiment, server 120 generates a psychometric assessment test respective of the one or more personal parameters, the answers received, the historical data, the at least one detail associated with the user's application and the psychometric score.

The principles of the invention may be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for assessing the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

A person skilled-in-the-art will readily note that other embodiments of the disclosure may be achieved without departing from the scope of the disclosure. All such embodiments are included herein. The scope of the disclosure should be limited solely by the claims thereto.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

1. A communication device for determining, prior to provisioning a service to a user of a computing device, whether said user may be provided with a requested service, wherein the communication device comprising:
a network interface configured to communicate with the computing device of said user and with at least one first processing device; and
at least one second processing device adapted to communicate with the network interface, wherein the at least second processing device is configured to:
receive from the computing device a request for a service to be provisioned to the user of the computing device;
forward to the at least one first processing device information associated with the request received, and at least one detail associated with the user of the computing device;
retrieve from the at least one first processing device data that relates to the request;
determine, based on the retrieved data, a set of queries;
transmit the set of queries to the computing device;
receive from the computing device one or more responses to queries included in the set of queries;
determine an adequacy score based on the retrieved data and the one or more responses; and
when the adequacy score is above a predefined threshold, enable provisioning the requested service to the user of the computing device.

2. The communication device of claim 1, wherein the requested service is receiving data content and the at least one detail associated with the user is an age or geographical location of the user.

3. The communication device of claim 2, wherein the set of queries includes at least one of: a query regarding the user experience with similar services, a query regarding a desired quality of service, and a query regarding a version of the data content.

4. The communication device of claim 2, wherein upon determining that the adequacy score is above the predefined threshold, a data file is forwarded towards the computing device.

5. The communication device of claim 2, wherein upon determining that the adequacy score is below the predefined threshold, suggesting a different data content to the user.

6. A computer program product encoding a computer program stored on a non-transitory computer-readable medium for executing a set of instructions by one or more computer processors for carrying out the method for performing an adequacy inspection prior to provisioning a service to a user of a computing device, wherein the method comprising:
receiving from the computing device a request for a service to be provided to the user of the computing device;
forwarding information associated with the request received, and at least one detail associated with the user of the computing device to at least one processing device;
retrieving from the at least one processing device data that relates to the request;
determining, based on the retrieved data, a set of queries;
forwarding the set of queries to the computing device;
receiving from the computing device one or more responses to queries included in the set of queries;
determining an adequacy score based on the retrieved data and the one or more responses; and
if the adequacy score is above a predefined threshold, enabling provisioning of the requested a service to the user of the computing device.

7. The computer program product of claim 6, wherein the requested service is receipt of data content.

8. The computer program product of claim 7, wherein upon determining that the adequacy score is above the predefined threshold, a data file is forwarded towards the computing device.
